(19) United States
(12) Patent Application Publication
(10) Pub. No.: US 2011/0204792 A1
(43) Pub. Date: Aug. 25, 2011

(54) CURCUIT ARRANGEMENT AND METHOD FOR OPERATING AN OLED

(75) Inventor: Thomas Siegmund, Otterfing (DE)

(73) Assignee: OSRAM Gesellschaft mit beschraenkter Haftung, Muenchen (DE)

(21) Appl. No.: 13/127,482

(22) PCT Filed: Nov. 4, 2008
(86) PCT No.: PCT/EP2008/064927

§ 371 Date: May 4, 2011

(51) Int. Cl. H05B 37/02

(52) U.S. Cl. 315/119

(57) ABSTRACT

A circuit arrangement for operating an OLED may include a current source to supply the OLED with power; an OLED voltage measuring device configured to provide at its output a signal which is correlated with the voltage dropping across the OLED; an evaluation device configured to provide at its output a first signal if the voltage dropping across the OLED lies above a specifiable threshold value, and to provide a second signal if the voltage dropping across the OLED lies below the specifiable threshold value; an electronic switch having a reference electrode, a working electrode and a control electrode; and at least one ohmic resistor; wherein the series connection of the at least one ohmic resistor and the working electrode-reference electrode section of the electronic switch is connected in parallel with the OLED.

### TECHNICAL FIELD

The present invention relates to a circuit arrangement for operating an OLED, including a current source which is coupled to the OLED in order to supply the OLED with power. It furthermore relates to a method for operating an OLED.

### BACKGROUND ART

Commercially available OLEDs consist of millimeter-thin glass substrates, on the reverse side of which are applied the light-emitting material layers and the electrodes for contacting purposes. The glass of the OLED can break as a result of external mechanical influences. This leads to inhomogeneous current distribution in the substrate and in the applied OLED material layers. Depending on embodiment, in the case of a large crack this may result in a reduction in the size of the current-carrying area to the extent of a complete separation of the electrodes or to total interruption of the current flow.

In the event of such a fault situation this results—viewed from the outside—in an increase in the impedance of the OLED. In a series connection of a plurality of OLEDs the current is correctively adjusted to the constant value by the driver in response to the malfunction and consequently more power is delivered to the defective OLED. Only when a maximum output voltage of the OLEDs connected in series is exceeded does the driver switch off.

Early and rapid detection of such an individual OLED defect in a series connection is thus possible only with great difficulty because initially only a very small part of the current is impeded by the crack, which partial current cannot be separated by measurement technology means from the total current and during operation is additionally subjected to the fluctuations resulting from the OLED parameter spread of different batches.

The following estimate of the OLED voltages results during constant current operation: In the case of a series connection of 50 OLEDs and a total operating voltage of 200 V, a tolerance of approx. 10% in total is to be expected during normal operation. If the maximum output voltage is limited to +15%, the maximum output voltage is thus 230 V. 30 V is then present at the defective OLED instead of nominally 4 V. The power consumption at the defective OLED is inflated by a factor of 7.5 prior to turn-off. As a result of the inhomogeneous current flow, a further rise in power density may take place and local overheating of the regions of the defective OLED through which current passes can occur. In consequence thereof, predefined clearances and creepage distances, specifications regarding insulation and also the mechanical integrity can no longer be guaranteed. In the event of a complete break with interruption, approx. 200 V is even present at the site of the crack. The insulating light decoupling film may be damaged at these points and the insulation of the OLED may be adversely affected. To summarize, a considerable safety risk therefore exists.

From the prior art, such as for example the document US 20040201985 A1 or the data sheet for the LM3553 device from the company National Semiconductor, only linearly regulated or switched current drivers are known which are available for the operation of inorganic LEDs having input-side or output-side monitoring of a maximum voltage. These are not suitable for eliminating the safety risk.

### DESCRIPTION OF THE INVENTION

The object of the present invention therefore consists in developing a circuit arrangement as cited in the introduction or a method as cited in the introduction in such a manner that the existing safety risk can thereby be reduced when operating OLEDs.

This object is achieved by a circuit arrangement having the features recited in claim 1 and by a method having the features recited in claim 10.

The present invention is based firstly on the knowledge that OLED tolerances and parameter fluctuations add up unfavorably in a series connection. An improvement is therefore only possible by monitoring an individual OLED.

Since the OLED current flowing through the series connection of a plurality of OLEDs is always regulated to a constant value, the OLED voltage of an individual OLED provided by way of a network is therefore temporally analyzed by means of voltage threshold or voltage window. In this case the setting can be configured to be much more sensitive than when monitoring the output voltage of a driver driving the entire series connection of a plurality of OLEDs.

This enables an OLED break to be detected at an early stage, in particular already during the actual development phase. Local overheating at the OLED defect site can be reliably prevented. The circuit can be implemented by means of SMD components and integrated directly (chip on glass) or by means of flexible PCB on the rear of the OLED or in the mounting frame for the OLED. There is thus no longer a safety risk; the relevant safety requirements can be observed.

The damaged OLED is moreover deactivated by means of the electronic switch and the ohmic resistor on detection of an OLED break. Since the current then flows by way of the series connection of the ohmic resistor and the transistor, the other OLEDs of the series connection of a plurality of OLEDs can continue in operation without interruption.

In a preferred embodiment variant the evaluation device of the series connection includes a threshold value device, an amplifier device and a holding element. It is thus possible to ensure in a particularly simple manner that when a faulty OLED is detected the associated electronic switch is persistently driven by means of a signal, thus enabling the defective OLED to be bridged through the series connection consisting of the at least one ohmic resistor and the electronic switch.

By preference the threshold value device includes a Zener diode. By this means it is possible in a simple manner to define very precisely a voltage threshold which is used for detecting an OLED break.

The holding element is preferably configured to provide a voltage of a specifiable amplitude over a specifiable period of time. This permits the permanent actuation of the electronic switch and thus the permanent bridging of a defective OLED. The remaining OLEDs of the series connection can therefore continue permanently in operation.

The amplifier device and the holding element are therefore preferably configured to provide at their output a signal in particular for turning on the electronic switch.

In a preferred embodiment variant the evaluation device includes a voltage divider which is configured to provide at its tap a voltage which is correlated with the voltage dropping across the OLED. By this means it is in particular possible to generate a voltage which can be further processed by a microcontroller. In a preferred embodiment variant the threshold value device, the amplifier device and the holding element are therefore implemented by means of a microcontroller.

In order to filter out coupled-in interference and RF components it is furthermore preferred if a filter device is coupled between the OLED voltage measuring device and the evaluation device.

In a particularly preferred development the at least one resistor is dimensioned such that the voltage dropping across the series connection consisting of the at least one ohmic resistor and the working electrode-reference electrode section of the electronic switch can be used as the supply voltage for the evaluation device, in particular the holding element, and/or the electronic switch. As a result there is no need to provide any additional voltage supply for the said components, which means that a particularly cost-effective implementation becomes possible.

Further advantageous embodiment variants will emerge from the dependent claims.

The preferred embodiments and their advantages presented with reference to the circuit arrangement according to the invention are valid analogously, insofar as they are applicable, to the method according to the invention.

### BRIEF DESCRIPTION OF THE DRAWINGS

Exemplary embodiments of a circuit arrangement according to the invention will now be described in more detail below with reference to the attached drawings, in which:

FIG. 1 shows a first exemplary embodiment of a circuit arrangement according to the invention, implemented using discrete components;

FIG. 2 shows a second exemplary embodiment of a circuit arrangement according to the invention, though with parts of the evaluation device being implemented by means of a microcontroller;

FIG. 3 shows an exemplary embodiment in accordance with FIG. 1 in a more detailed view;

FIG. 4 shows the time characteristic for different signals of a circuit arrangement according to the invention measured on an intact OLED;

FIG. 5 shows the time characteristic for different signals of a circuit arrangement according to the invention measured on a defective OLED; and

FIG. 6 shows the time characteristic for different signals measured on a circuit arrangement according to the invention during load shedding.

The same reference characters are used for identical and similar components in the different embodiment variants. They are therefore introduced only once.

### PREFERRED EMBODIMENT OF THE INVENTION

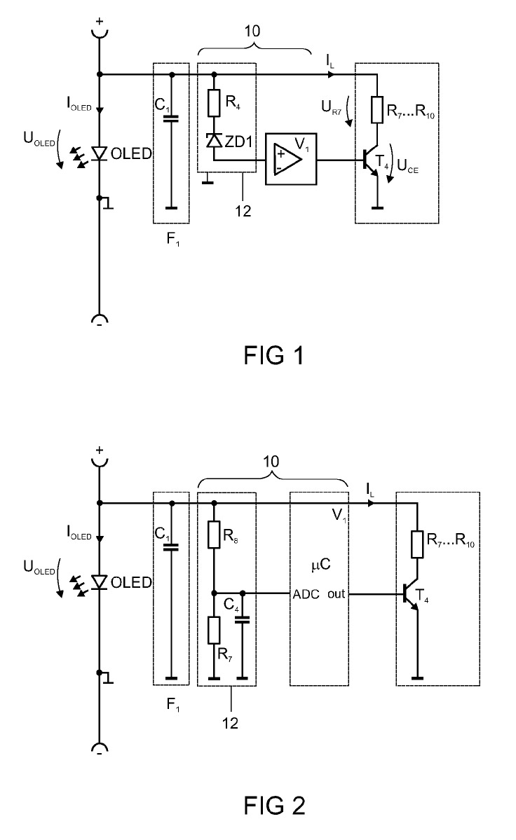

FIG. 1 shows a schematic representation of a first exemplary embodiment of a circuit arrangement according to the invention. In this case an OLED is connected in series between a voltage supply. The current flowing through the OLED is designated by I_{OLED}, the voltage dropping across the OLED is designated by U_{OLED}. A filter F₁, implemented in the present example by means of a capacitor C₁, serves to filter out coupled-in interference and RF components. An evaluation device 10 includes a threshold value device 12 on the one hand and a stage V₁ having an amplifier device and a holding element on the other hand. The threshold value device 12 includes the series connection of an ohmic resistor R₄ and a Zener diode ZD₁. The output from the stage V₁ is coupled to the control electrode of an electronic switch T₄ which, together with the parallel connection of ohmic resistors R₇ to R₁₀, is connected in parallel with the OLED. The threshold value device 12 and the stage V₁ are configured such that if the OLED voltage U_{OLED} is greater than the reverse breakdown voltage of the Zener diode ZD₁ this results in the stage V₁ being driven at full power. The fully driven state is maintained permanently by means of a holding element at the output. This state corresponds to the status in the case of a faulty OLED.

The then positive output signal from the stage V₁ is fed to the base of the transistor T₄ which then switches through and effects low-impedance bridging of the defective OLED by way of the load resistors R₇ to R₁₀ and thus takes over the current.

It should be noted in particular that the resistors R₇ to R₁₀ connected in parallel are dimensioned in such a manner that the total voltage drop from U_{R7}+U_{CE}(T₄) is sufficient for supplying the circuit arrangement, in particular the holding element and the electronic switch T₄.

The connecting lines between OLED and evaluation device 10 serve in the present example as an OLED voltage measuring device.

Referring now to FIG. 2, the threshold value device 12 includes a voltage divider with the resistors R₇ and R₈, wherein a capacitor C₄ is connected in parallel with the resistor R₇. The stage V₁ is implemented by means of a microprocessor μC, the input of which is coupled to the tap of the voltage divider R₈/R₇, C₄ and the output of which is coupled to the base of the transistor T₄.

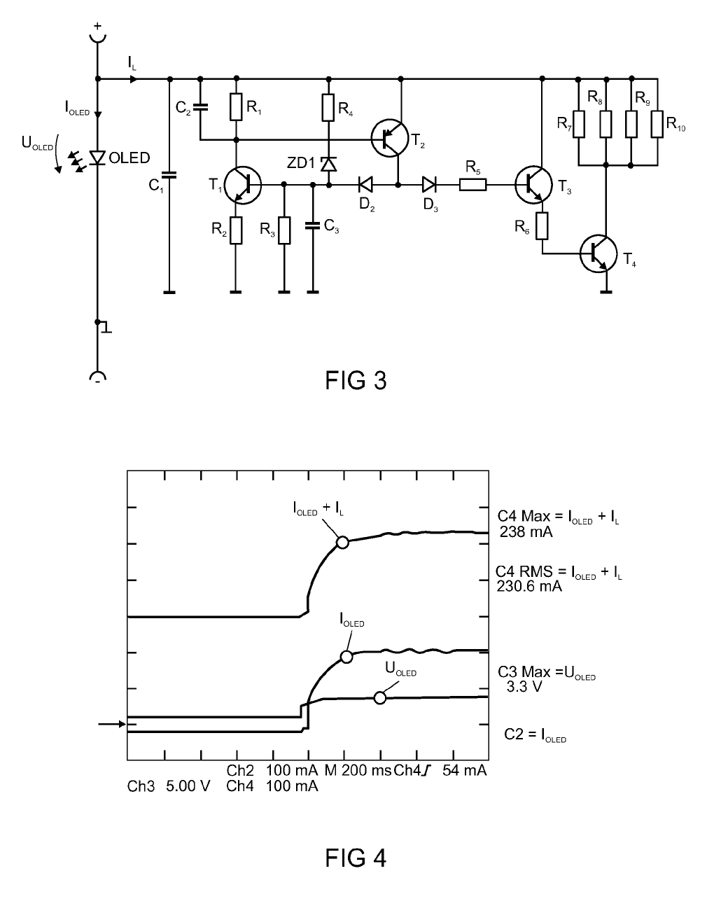

FIG. 3 shows in greater detail an exemplary embodiment of the basic principle schematically illustrated in FIG. 1. In this case the filter F₁ is implemented by means of the capacitor C₁. The evaluation device 10 includes the ohmic resistor R₄ and the Zener diode ZD₁. The stage V₁ includes the components C₂, R₁, T₁, R₂, R₃, C₃, D₂, T₂, D₃. The electronic switch and the load include the components R₅, T₃, R₆, T₄, R₂, R₃, R₉ and R₁₀.

In a preferred exemplary embodiment according to FIG. 3 the Zener diode ZD₁ is dimensioned such that the OLED is turned off if the voltage U_{OLED} exceeds twice the rated value. In other embodiment variants the turn-off threshold may occur when the rated value is exceeded by between 10% and 300%.

As can be seen from FIG. 3, the circuit arrangement consists of a few SMD components, functions autonomously and obtains its own voltage supply from the OLED current I_{OLED}. In the event of OLED failure during operation, the defective OLED is typically deactivated in the order of less than 2.3 μs. The current flow is taken over on a permanent low-impedance basis by the electronic switch T₄, with the result that only the damaged OLED remains dark and no further overheating or flashovers take place.

FIG. 4 shows the time characteristic of the current I_{OLED} through the OLED, of the voltage U_{OLED} dropping across the OLED and of the sum of the current I_{OLED} through the OLED and the current I_{L} through the circuit structure connected in parallel with the OLED. As can be clearly seen, after turn-on the voltage U_{OLED} rises very rapidly to a constant value while the current I_{OLED} through the OLED in contrast rises only gradually to a constant value. The same holds true for the sum of the current I_{OLED} and the current I_{L}. The current I_{L} is thus approximately zero. The OLED in question is therefore an intact OLED.

FIG. 5 shows the corresponding time characteristics for a defective OLED: After turn-on the voltage U_{OLED} across the OLED rises rapidly for a short time. According to the invention this is registered by the protection device and leads to the switch T₄ being driven to conducting. The current I=through the OLED therefore remains zero, the switch T₄ takes over the current which in the example shown in FIG. 4 flowed through the OLED. As can clearly be recognized, the detection takes place already shortly after turn-on during start-up of the arrangement, in particular at currents I_{OLED}<600 μA.

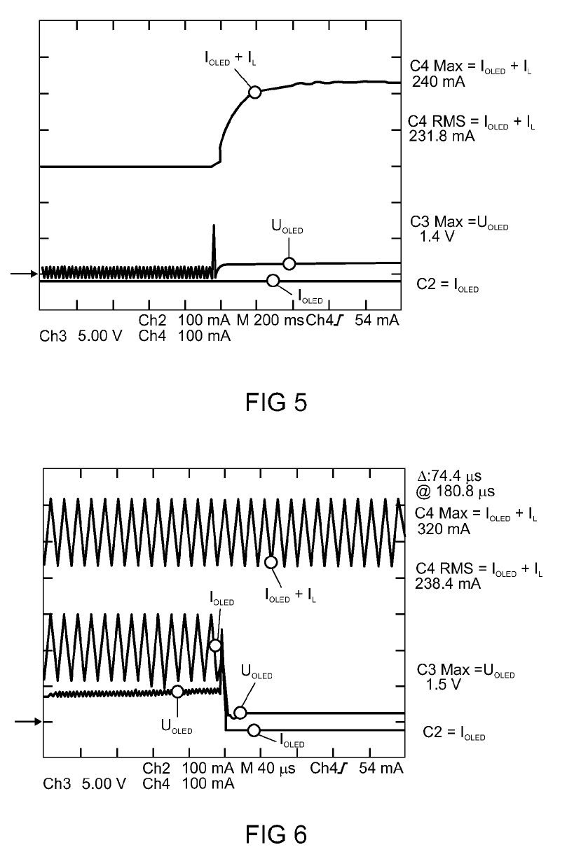

FIG. 6 shows the timing characteristic for the corresponding variables during load shedding. It can be seen that here too the protection circuit responds following a short rise in the voltage U_{OLED} and in consequence the current I_{OLED} drops back to zero. As can be seen from the characteristic for the total current I_{OLED}+I_{L}, the entire current now flows by way of the switch T₄, the remaining OLEDs of a series connection of a plurality of OLEDs are therefore supplied with current. Only the defective OLED has been disabled.

1. A circuit arrangement for operating an OLED, the circuit arrangement comprising:
a current source which is coupled to the OLED in order to supply the OLED with power;
an OLED voltage measuring device which is coupled to the OLED and is configured to provide at its output a signal which is correlated with the voltage dropping across the OLED;
an evaluation device which is coupled to the output of the OLED voltage measuring device and is configured to provide at its output a first signal if the voltage dropping across the OLED lies above a specifiable threshold value, and to provide a second signal if the voltage dropping across the OLED lies below the specifiable threshold value;
an electronic switch having a reference electrode, a working electrode and a control electrode, wherein the control electrode is coupled to the output of the evaluation device; and
at least one ohmic resistor;
wherein the series connection of the at least one ohmic resistor and the working electrode-reference electrode section of the electronic switch is connected in parallel with the OLED.

2. The device as claimed in claim 1,
wherein
the evaluation device comprises the series connection of a threshold value device, an amplifier device and a holding element.

3. The device as claimed in claim 2,
wherein
the threshold value device includes a Zener diode.

4. The device as claimed in claim 2,
wherein
the holding element is configured to provide a voltage of a specifiable amplitude over a specifiable period of time.

5. The device as claimed in claim 2,
wherein
the amplifier device and the holding element are configured to provide at their output a signal for turning on the electronic switch.

6. The device as claimed in claim 1,
wherein
the evaluation device comprises a voltage divider which is configured to provide at its tap a voltage which is correlated with the voltage dropping across the OLED.

7. The device as claimed in claim 2,
wherein
the threshold value device, the amplifier device and the holding element are implemented by means of a microcontroller.

8. The device as claimed in claim 1
wherein
a filter device is coupled between the OLED voltage measuring device and the evaluation device.

9. The device as claimed in claim 1
wherein
the at least one resistor is dimensioned such that the voltage dropping across the series connection of the at least one ohmic resistor and the working electrode-reference electrode section of the electronic switch is configured to be used as the supply voltage for the evaluation device.

10. A method for operating an OLED, the method comprising:
supplying the OLED from a current source;
measuring the voltage dropping across the OLED;
evaluating the measured voltage and providing a first signal if the voltage dropping across the OLED lies above a specifiable threshold value, and providing a second signal if the voltage dropping across the OLED lies below the specifiable threshold value; and
coupling the first or the second signal to the control electrode of an electronic switch, wherein the working electrode-reference electrode section of the electronic switch is connected in series with at least one ohmic resistor and wherein said series connection is connected in parallel with the OLED.

11. The device as claimed in claim 9,
wherein the working electrode-reference electrode section of the electronic switch is configured to be used as the supply voltage for at least one of the holding element and the electronic switch.
